(19) United States
(12) Patent Application Publication
(10) Pub. No.: US 2026/0288041 A1
(43) Pub. Date: Sep. 24, 2026

(54) REPLENISHMENT MANAGEMENT SYSTEM INCLUDING IMAGE FORMING APPARATUS AND SERVER APPARATUS

(71) Applicant: CANON KABUSHIKI KAISHA, Tokyo (JP)

(72) Inventors: SHUICHI TETSUNO, Kanagawa (JP); SHUNSUKE MATSUSHITA, Kanagawa (JP); MIKIHIKO HAMADA, Kanagawa (JP)

(21) Appl. No.: 19/562,521

(22) Filed: Mar. 10, 2026

(30) Foreign Application Priority Data
Mar. 24, 2025 (JP) 2025-049023

(51) Int. Cl. G03G 15/00; G03G 15/08; G06F 3/12

(52) U.S. Cl. CPC G03G 15/5079; G03G 15/0856; G03G 15/0863; G03G 15/556; G06F 3/1293

(57) ABSTRACT

The present disclosure relates to a system including an image forming apparatus and a server apparatus. The image forming apparatus includes a storage portion configured to store toner replenished from an attached toner container, a detection unit configured to detect a remaining amount of toner in the storage portion, and a notification unit configured to notify the server apparatus of information about the detected remaining amount of toner. In a case where a new toner container to be used for the image forming apparatus is delivered, the server apparatus determines whether the image forming apparatus has been appropriately replenished with toner based on a toner content of the toner container and the remaining amount of toner notified from the image forming apparatus after the toner container is delivered.

### BACKGROUND

### Field of the Technology

The present disclosure relates to a replenishment management system including an image forming apparatus and a server apparatus.

### Description of the Related Art

In a system including an image forming apparatus and a server apparatus that communicates with the image forming apparatus via a network, a service in which the server apparatus recognizes a shortage of toner remaining in the image forming apparatus and automatically delivers a toner container accommodating toner has recently been widely used. According to the system that provides such a service, when a toner container is delivered to a user who uses the image forming apparatus, the user attaches the toner container to the image forming apparatus and performs a toner replenishment operation (see United States Patent Application Publication No. US 2024/0094672).

However, if the image forming apparatus is not appropriately replenished with toner accommodated in the delivered toner container, a situation in which the toner is depleted at an unexpected timing can occur. Therefore, it is desirable that the server apparatus that manages delivery of the toner container grasp whether the image forming apparatus has been appropriately replenished with toner from the delivered toner container.

### SUMMARY

According to an aspect of the present disclosure, a replenishment management system includes an image forming apparatus to which a toner container accommodating toner to be used for image formation is detachably attachable, and a server apparatus configured to manage delivery of the toner container to be used for the image forming apparatus, wherein the image forming apparatus includes: a storage portion configured to store toner replenished from the attached toner container, at least one memory that stores a set of instructions, at least one processor that executes the instructions causing the image forming apparatus to perform operations comprising a detection unit configured to detect a remaining amount of toner in the storage portion, and a notification unit configured to notify the server apparatus of information about the remaining amount of toner detected by the detection unit, and wherein the server apparatus includes at least one memory that stores a set of instructions, at least one processor that executes the instructions causing the server apparatus to perform operations comprising a determination unit configured to determine whether toner replenishment from the toner container to the image forming apparatus has been appropriately performed based on information about a content of toner accommodated in a new toner container in a case where the new toner container to be used for the image forming apparatus is delivered, and information about the remaining amount of toner notified from the image forming apparatus after the toner container is delivered.

With this configuration, the server apparatus can grasp whether the image forming apparatus has been appropriately replenished with toner from a delivered toner container.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are schematic perspective views each illustrating an example of appearance of an image forming apparatus.

FIG. 2 is a schematic sectional view illustrating an example of a configuration of the image forming apparatus.

FIG. 3 is a schematic perspective view illustrating an example of a configuration of a consumable material replenishment path.

FIG. 4 is a schematic sectional view illustrating an example of a configuration of a storage portion and a peripheral portion thereof.

FIGS. 5A and 5B are schematic perspective views each illustrating an example of a schematic configuration of a replenishment pack.

FIGS. 6A and 6B are explanatory diagrams illustrating opening and closing of a discharge tray.

FIG. 7 is an explanatory diagram illustrating a state where the replenishment pack is connected to a toner receiving portion.

FIGS. 8A and 8B are explanatory diagrams each illustrating an example of a lock mechanism for locking an operation of an opening/closing mechanism.

FIG. 9 is a schematic diagram illustrating an example of a configuration of a replenishment management system.

FIG. 10 is a block diagram illustrating an example of a configuration of a management server.

FIG. 11 is an explanatory diagram illustrating an example of updating a database during apparatus registration.

FIG. 12 is an explanatory diagram illustrating an example of updating a database during pack delivery.

FIG. 13 is a block diagram illustrating an example of a functional configuration of the image forming apparatus according to an embodiment.

FIGS. 14A and 14B are sequence diagrams each illustrating a flow of processing of an example including provision of a replenishment pack and replenishment according to the first embodiment.

FIG. 15 is a flowchart illustrating replenishment determination according to the first embodiment.

FIG. 16 is a flowchart illustrating replenishment determination according to a second embodiment.

FIGS. 17A and 17B are sequence diagrams each illustrating a flow of processing of an example including provision of a replenishment pack and replenishment according to the second embodiment.

### DESCRIPTION OF THE EMBODIMENTS

### First Embodiment

### Description of Replenishment Type Image Forming Apparatus

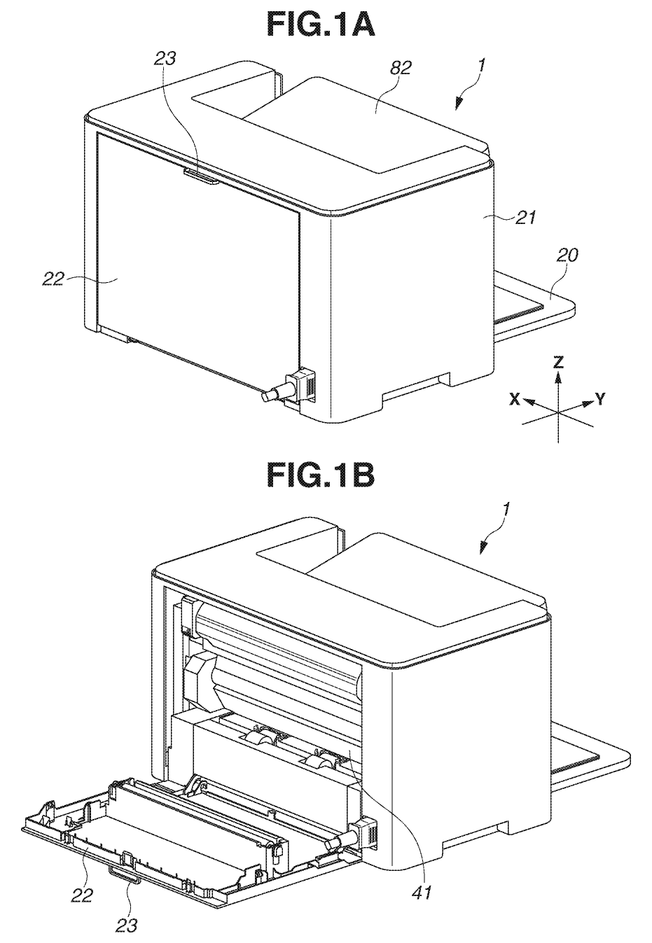

In this section, a basic configuration of a replenishment type image forming apparatus will be described with reference to FIGS. 1A to 8B. An example of a configuration of an image forming apparatus 1 that is a monochromatic laser printer will be described below.

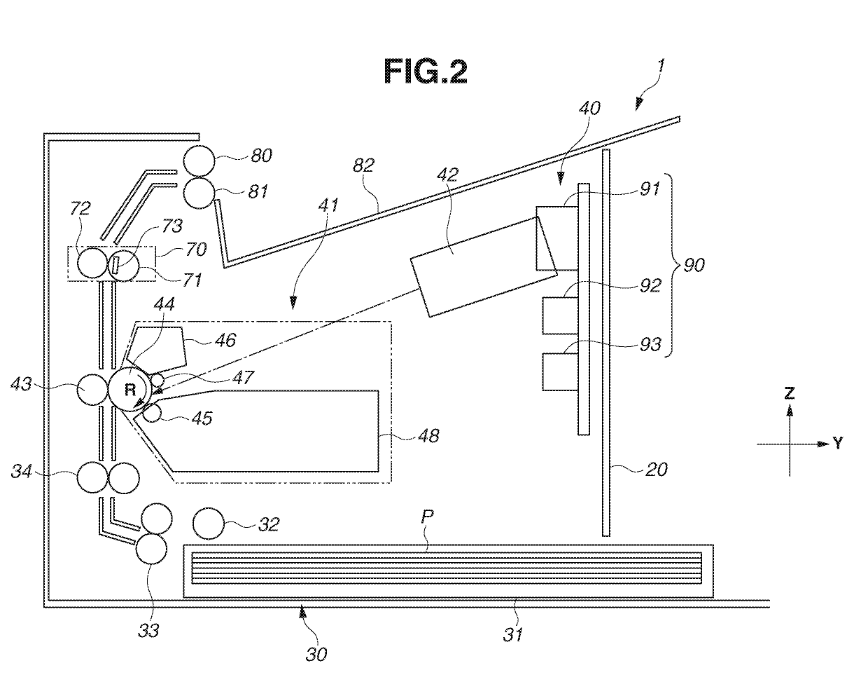

FIGS. 1A and 1B are schematic perspective views each illustrating an example of appearance of the image forming apparatus 1. FIG. 2 is a schematic sectional view illustrating an example of a physical internal configuration of the image forming apparatus 1. The image forming apparatus 1 is a monochromatic laser printer that forms an image on a recording medium based on input image data. Examples of the recording medium include various media made of different materials, such as paper, a plastic film, an envelope, a sheet, and cloth.

In the following description, a height direction of the image forming apparatus 1 when the image forming apparatus 1 is placed on a horizontal plane is defined as a Z-direction, and a direction that is orthogonal to the Z-direction and is parallel to a rotational axis direction (main scanning direction) of a photosensitive drum 44 to be described below is defined as an X-direction. A direction that is orthogonal to both of the X-direction and the Z-direction is defined as a Y-direction.

### Appearance of Apparatus

A housing of the image forming apparatus 1 includes a front cover 20 (see FIG. 2), an exterior cover 21, a rear cover 22, and a discharge tray 82 (see FIGS. 1A and 1B). The rear cover 22 is provided with a handle 23. The front cover 20 is provided on one side surface of the image forming apparatus 1 in such a manner that the front cover 20 can be opened and closed, and protects a processing circuit 90 to be described below. The rear cover 22 is provided on another side surface of the image forming apparatus 1 in such a manner that the rear cover 22 can be opened and closed.

A user can open the rear cover 22 by gripping the handle 23 of the rear cover 22, thereby allowing a process unit 41 and a part of a conveyance path through which the recording medium is conveyed to be exposed, so that the user can perform a maintenance operation such as removal of jamming or replacement of the process unit 41. FIG. 1A illustrates a state where the rear cover 22 is closed, and FIG. 1B illustrates a state where the rear cover 22 is open.

### Internal Configuration of Apparatus

As illustrated in FIG. 2, the image forming apparatus 1 includes a feed unit 30, an image forming unit 40, a fixing unit 70, a discharge roller pair 80, and the processing circuit 90. The feed unit 30 feeds a recording medium P to the image forming unit 40. The image forming unit 40 forms a toner image on the recording medium P with toner, which is an example of a consumable material. The fixing unit 70 fixes the toner image formed by the image forming unit 40 onto the recording medium P. The discharge roller pair 80 discharges the recording medium P processed by the fixing unit 70 to the discharge tray 82.

The image forming unit 40 includes the process unit 41, a scanner unit 42, and a transfer roller 43. The process unit 41 includes the photosensitive drum 44, a development roller 45, a cleaning unit 46, a charging roller 47, and a storage portion 48. The process unit 41 may be fixed to a main body of the image forming apparatus 1 or may be detachably mounted thereto.

The photosensitive drum 44 is an image bearing member and has a photosensitive layer formed of an organic photoconductor on a drum-shaped base member. The photosensitive drum 44 is rotationally driven by a motor in a direction indicated by an arrow R. A charging voltage is applied to the charging roller 47 by a high-voltage power supply, and the charging roller 47 is brought into pressure contact with the photosensitive drum 44 to uniformly charge a surface of the photosensitive drum 44. The scanner unit 42 irradiates the photosensitive drum 44 with laser light in accordance with input image data to expose the surface of the photosensitive drum 44. As a result of this exposure, an electrostatic latent image corresponding to the input image data is formed on the surface of the photosensitive drum 44. The scanner unit 42 may irradiate the photosensitive drum 44 not with laser light, but with light from a light-emitting diode (LED) array.

The development roller 45 is rotatably supported by the storage portion 48. The storage portion 48 stores toner. Although not illustrated in FIG. 2, the storage portion 48 further includes a supply roller to apply toner stored in the storage portion 48 to the surface of the development roller 45. A development voltage is applied to the development roller 45 by the high-voltage power supply. When the toner carried on the development roller 45 comes into contact with the photosensitive drum 44, the toner is transferred to the surface of the photosensitive drum 44 from the development roller 45 in accordance with a potential distribution on the surface of the photosensitive drum 44. Thus, the electrostatic latent image is developed into a toner image.

The feed unit 30 includes a cassette 31, a pickup roller 32, a separation roller pair 33, and a conveyance roller pair 34. The cassette 31 can be drawn out of the housing of the image forming apparatus 1, and a bundle of recording media P is stacked on the cassette 31. The pickup roller 32 picks up the recording medium P in the cassette 31, and feeds the recording medium P toward the separation roller pair 33. The separation roller pair 33 separates the recording media P one by one and conveys a recording medium P toward the conveyance roller pair 34. The conveyance roller pair 34 conveys the recording medium P toward a transfer nip between the transfer roller 43 and the photosensitive drum 44.

A transfer voltage is applied to the transfer roller 43 from the high-voltage power supply, and the transfer roller 43 transfers the toner image developed on the surface of the photosensitive drum 44 onto the recording medium P that has been conveyed to the transfer nip.

The recording medium P onto which the toner image is transferred is conveyed along the conveyance path and reaches the fixing unit 70. The fixing unit 70 includes a heating roller 71, a pressure roller 72, and a fixing heater 73. The heating roller 71 and the pressure roller 72 heat and pressurize the recording medium P when the recording medium P passes through a fixing nip between these rollers. Thus, toner particles melt and then solidify, whereby the toner image is fixed to the recording medium P. The recording medium P that has passed through the fixing unit 70 is discharged by the discharge roller pair 80 to the discharge tray 82 through a discharge port 81. The cleaning unit 46 is disposed in the vicinity of the photosensitive drum 44. The cleaning unit 46 cleans the photosensitive drum 44 by scraping off residual toner on the surface of the photosensitive drum 44.

The processing circuit 90 includes a group of electronic components 91, 92, and 93 disposed on a substrate. The electronic component 91 is, for example, a central processing unit (CPU). The electronic component 92 is, for example, a memory. The electronic component 93 is, for example, an input/output device. The input/output device includes a communication interface. When a job that instructs the image forming apparatus 1 to perform image formation is input to the image forming apparatus 1, for example, an image formation process based on input image data received from an external computer is started. In the image formation process, as described above, the scanner unit 42 forms an electrostatic latent image on the photosensitive drum 44 in accordance with the input image data, and the development roller 45 develops the electrostatic latent image into a toner image. Then, the transfer roller 43 transfers the toner image onto the recording medium P. The processing circuit 90 operates as a controller for controlling the image formation process.

### Detailed Configuration of Storage Portion

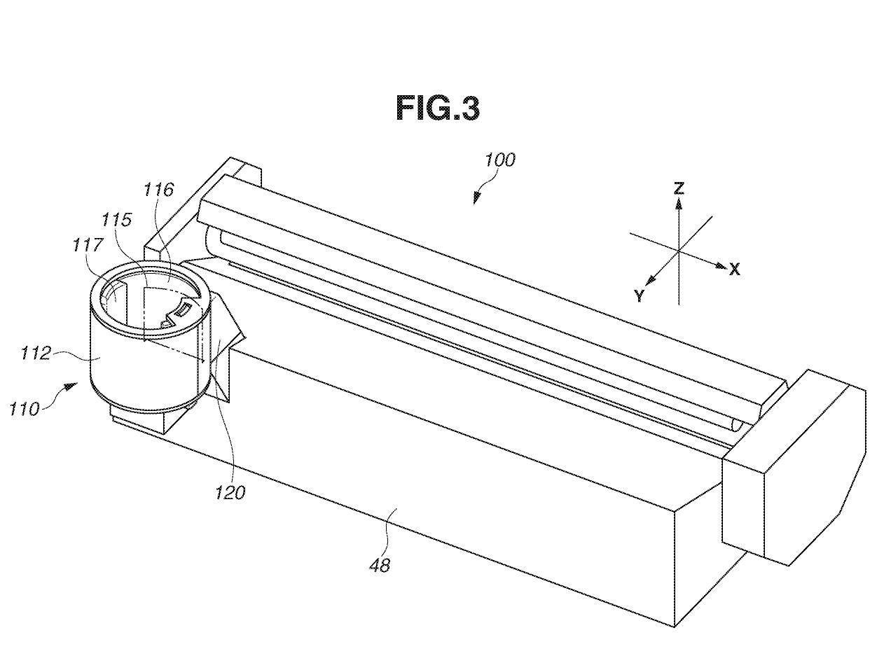

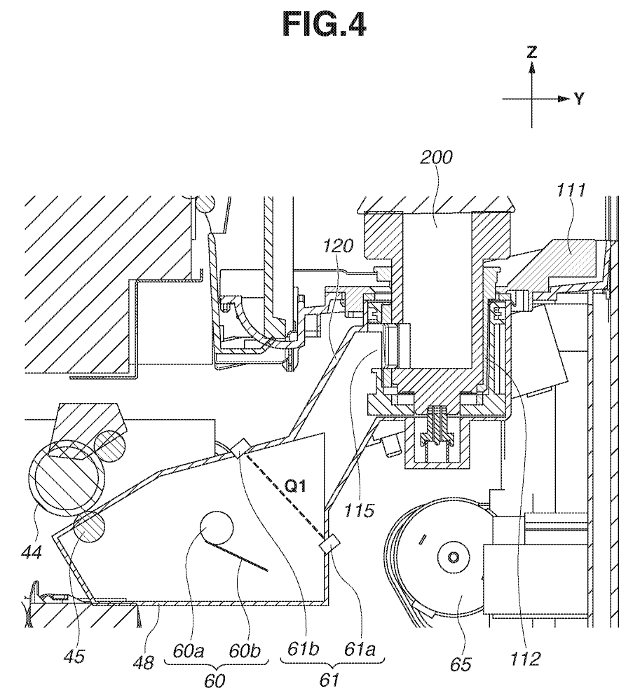

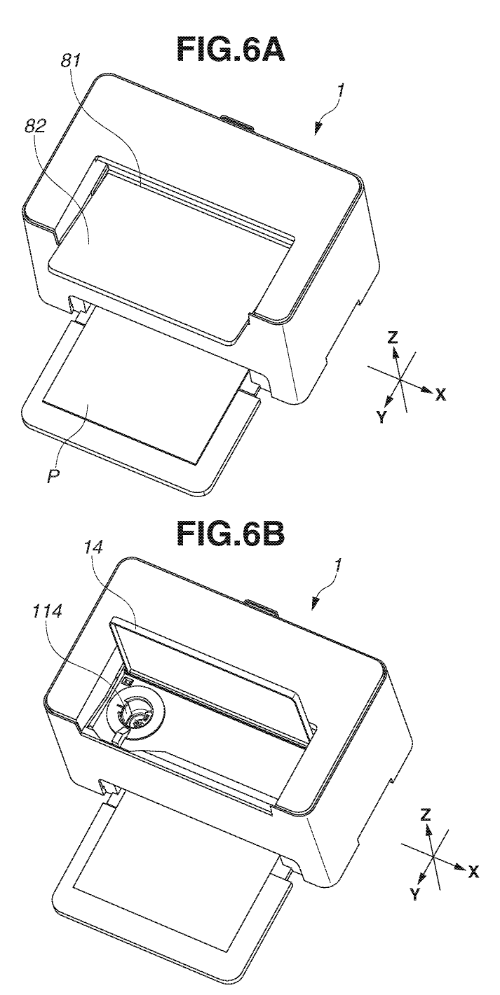

A configuration related to the storage portion 48 will be described with reference to FIGS. 3 and 4. FIG. 3 is a schematic perspective view illustrating an example of a configuration of a consumable material replenishment path in the image forming apparatus 1. FIG. 4 is a schematic sectional view illustrating an example of a configuration of the storage portion 48 and a configuration of a peripheral portion thereof. As illustrated in FIG. 3, the storage portion 48 constitutes a part of a toner replenishment unit 100. The toner replenishment unit 100 includes the storage portion 48 and a toner receiving portion 110. The toner receiving portion 110 includes a cylindrical member 112, a main body shutter 116, and a connection member 120. The toner receiving portion 110 further includes a ring member 111 to be described in detail with reference to FIGS. 6A to 8B. However, in FIG. 3, illustration of the ring member 111 is omitted to illustrate other components. An internal space of the cylindrical member 112 communicates with the storage portion 48 via a side surface opening 115 and the hollow connection member 120. The main body shutter 116 functions as an opening/closing mechanism configured to open or close a replenishment path from a replenishment pack 200 to be described below to the storage portion 48. On an inner surface of the main body shutter 116, a projection 117 is formed.

FIG. 4 illustrates a state where the replenishment pack 200 is attached to the toner receiving portion 110 and also illustrates a sectional view of the storage portion 48 and the configuration of the peripheral portion thereof. The replenishment pack 200 is an example of a toner container that accommodates a consumable material to be consumed for image formation. The replenishment pack 200 is detachably mountable to the image forming apparatus 1. When the main body shutter 116 is opened, the replenishment path that extends from the replenishment pack 200 to the storage portion 48 via the connection member 120 is opened. In a state where the replenishment path is opened, toner discharged from the replenishment pack 200 is supplied to the storage portion 48 through the replenishment path.

As illustrated in FIG. 4, an agitation member 60 including a shaft 60a that is disposed in the X-direction and a blade 60b that rotates around the shaft 60a is provided inside the storage portion 48. The blade 60b is driven by a motor 65 to rotate. By rotation of the blade 60b, the toner in the storage portion 48 is agitated and reaches the development roller 45. The agitation member 60 may include a spiral member in place of the blade 60b. The agitation member 60 has a role of homogenizing the toner in the storage portion 48 by scraping off toner from the development roller 45 and circulating the toner within the storage portion 48.

The storage portion 48 is further provided with a remaining amount detection unit 61. The remaining amount detection unit 61 is a sensor for detecting the remaining amount of toner in the storage portion 48, and is an example of a detection unit that detects the amount of consumable material. The remaining amount detection unit 61 includes a light emitter 61a and a light receiver 61b. The light emitter 61a emits light that travels within the storage portion 48 along an optical axis Q1. The light receiver 61b is disposed at a position facing the light emitter 61a and receives the light emitted from the light emitter 61a. The light receiver 61b is, for example, a phototransistor, a photodiode, or an avalanche photodiode.

The light receiver 61b outputs a photodetection signal having a signal level dependent on the amount of received light.

The photodetection signal is input to the processing circuit 90, for example, after being analog-to-digital converted. The processing circuit 90 may estimate the remaining amount of toner based on, for example, a ratio of a time during which the light from the light emitter 61a is blocked (by the toner) within a predetermined time window while the toner is being agitated. The configuration of the remaining amount detection unit 61 is not limited to the above-described example of the configuration. The remaining amount of toner may be detected or estimated by any other method. For example, the remaining amount of toner may be estimated by subtracting, from a total amount of toner at a time of previous toner replenishment, a cumulative amount of toner used thereafter. The processing circuit 90 may derive the amount of toner used based on a statistical value relating to an image formation operation, such as the number of recording media P consumed by printing or a pixel count.

### Configuration of Replenishment Pack

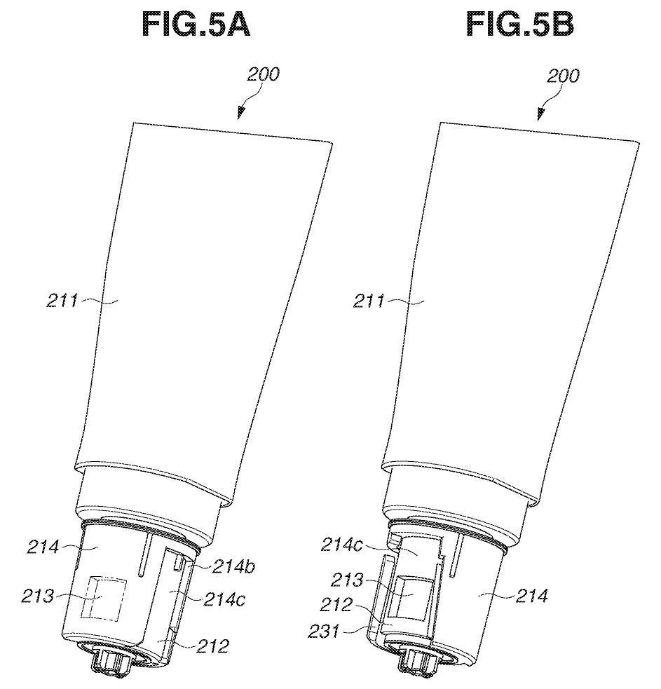

FIGS. 5A and 5B each illustrate an example of a schematic configuration of the replenishment pack 200. The replenishment pack 200 includes an accommodation portion 211, a nozzle 212, and a pack shutter 214. The accommodation portion 211 is configured as a hollow tube or pouch to accommodate toner, which is a consumable material. The accommodation portion 211 is filled with toner in advance. The accommodation portion 211 may be a readily deformable plastic bag. However, the accommodation portion 211 is not limited to these examples. The accommodation portion 211 may be formed of any material such as a resin, paper, or vinyl, and may have any shape such as a bottle shape, a cylindrical shape, or a box shape.

The nozzle 212 is an interface portion with the toner receiving portion 110 of the image forming apparatus 1. The inside of the nozzle 212 communicates with the inside of the accommodation portion 211. On a side surface of the nozzle 212, an opening 213 for discharging toner to the outside is formed. The opening 213 is closed with the pack shutter 214 in a normal state.

The pack shutter 214 is a cylindrical member concentric with the nozzle 212, and is disposed on an outer side of the nozzle 212 in a radial direction. The pack shutter 214 includes an opening 214c. A part of an edge portion forming the opening 214c constitutes a drive transmission surface 214b. During toner replenishment, the pack shutter 214 rotates relative to the nozzle 212 such that the opening 213 of the nozzle 212 is aligned with the opening 214c of the pack shutter 214, thereby making it possible to open a toner discharge path that has been closed by the pack shutter 214. As described below, the drive transmission surface 214b serves as a surface that receives a force for rotating the pack shutter 214. FIG. 5A illustrates a state where the toner discharge path is closed, and FIG. 5B illustrates a state where the toner discharge path is open. On an inner circumferential surface of the pack shutter 214, a sealing member 231 that shields the opening 213 of the nozzle 212 in a normal state may be further disposed. The sealing member 231 prevents toner from leaking from the replenishment pack 200 during a period in which toner replenishment is not performed.

### Replenishment of Consumable Material

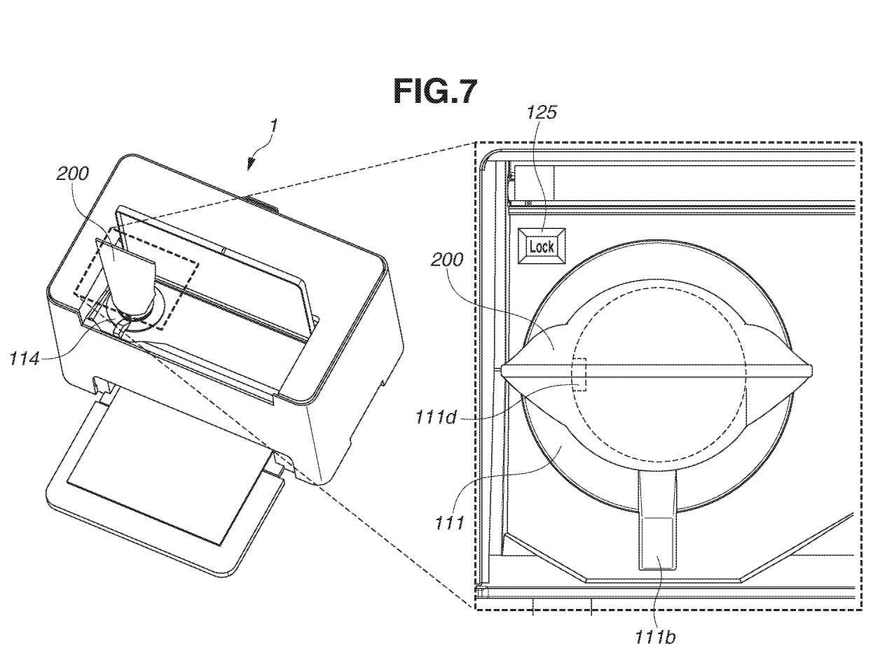

Connection of the replenishment pack 200 to the toner receiving portion 110 will be described with reference to FIGS. 6A and 6B and FIG. 7. As illustrated in FIGS. 6A and 6B, the discharge tray 82 is configured to be openable and closable about an opening/closing shaft disposed in the housing along the X-direction. In the example illustrated in FIG. 6A, the discharge tray 82 is in a closed state, and the recording medium P discharged from the discharge port 81 is discharged onto the discharge tray 82 in this state. In the example illustrated in FIG. 6B, the discharge tray 82 is in an open state, and a replenishment port 114 of the toner receiving portion 110 is exposed in this state. In other words, in this example of the configuration, the discharge tray 82 also functions as a shielding member that shields the replenishment port 114. The user lifts and opens the discharge tray 82 as in FIG. 6B and inserts the nozzle 212 of the replenishment pack 200 into the exposed replenishment port 114 as illustrated in a left figure in FIG. 7, thereby making it possible to connect the replenishment pack 200 to the toner receiving portion 110.

A right figure in FIG. 7 illustrates an enlarged view of a state where the replenishment pack 200 is connected to the toner receiving portion 110. The ring member 111 that surrounds the replenishment port 114 is rotatably supported on a top surface of the cylindrical member 112. The ring member 111 includes a lever 111b to be gripped by the user, and a projection 111d indicated by a dashed line in FIG. 7. The projection 111d engages with the drive transmission surface 214b of the pack shutter 214 of the replenishment pack 200 inserted into the toner receiving portion 110. The drive transmission surface 214b also engages with the projection 117 (see FIG. 3) of the main body shutter 116. When the user operates the lever 111b to rotate the ring member 111 about a central axis, a force generated in a rotational direction is transmitted from the projection 111d to the drive transmission surface 214b of the pack shutter 214, and is further transmitted from the drive transmission surface 214b to the projection 117 of the main body shutter 116. Thus, the main body shutter 116 and the pack shutter 214 of the replenishment pack 200 rotate in conjunction with the ring member 111, so that the toner replenishment path is opened, for example, after a rotation of 90 degrees. When the replenishment path is opened, toner accommodated in the accommodation portion 211 of the replenishment pack 200 is injected into the toner receiving portion 110 through the opening 213 of the nozzle 212, passes through the connection member 120, and is supplied to the storage portion 48. The rotation of the ring member 111 is regulated by a regulation member (not illustrated) so that the ring member 111 is not rotated beyond a predetermined upper limit angle.

In the example described above, the toner replenishment path is opened with the force generated in the rotational direction by the user operating the lever 111b. However, the toner replenishment path may be closed or opened without relying on a user operation. For example, the image forming apparatus 1 may include a pack sensor for detecting that the replenishment pack 200 is connected to the toner receiving portion 110, and a drive motor for generating a drive force to rotate the ring member 111. In this example, the processing circuit 90 may, on condition that the connection of the replenishment pack 200 to the toner receiving portion 110 is detected by the pack sensor, actuate the drive motor and rotate the ring member 111 with a rotational force of the drive motor to open the replenishment path.

The opening/closing mechanism for opening and closing the replenishment path is not limited to the mechanism that uses the rotation of the shutter as described above. Instead of using the shutter that rotates, a shutter movable linearly may be employed, or a mechanism different from a shutter, such as a valve, may be employed. The opening/closing mechanism may be disposed in at least one of the toner container, such as the replenishment pack 200, and the image forming apparatus 1. In other words, the replenishment path from the toner container to the image forming apparatus 1 may be always open in one of the toner container and the image forming apparatus 1, and may be opened or closed only in the other of the toner container and the image forming apparatus 1. Alternatively, the replenishment path may be opened or closed in both of the toner container and the image forming apparatus 1, as in the example described above. Further, a sensor for detecting an operation by the user on the opening/closing mechanism or detecting the state (open state or closed state) of the opening/closing mechanism may be additionally disposed.

The operation (by a user operation or an automatic actuation) of the opening/closing mechanism described above is inhibited by a lock mechanism to be described below. As with the opening/closing mechanism, the lock mechanism is disposed in at least one of the toner container and the image forming apparatus 1. To the replenishment port 114 of the image forming apparatus 1 or the opening 213 of the replenishment pack 200, a leakage prevention member, such as a lid or a cap, for preventing leakage of toner is attached. Such a leakage prevention member can be freely detached by the user at any time.

### Locking and Unlocking of Opening/Closing Mechanism

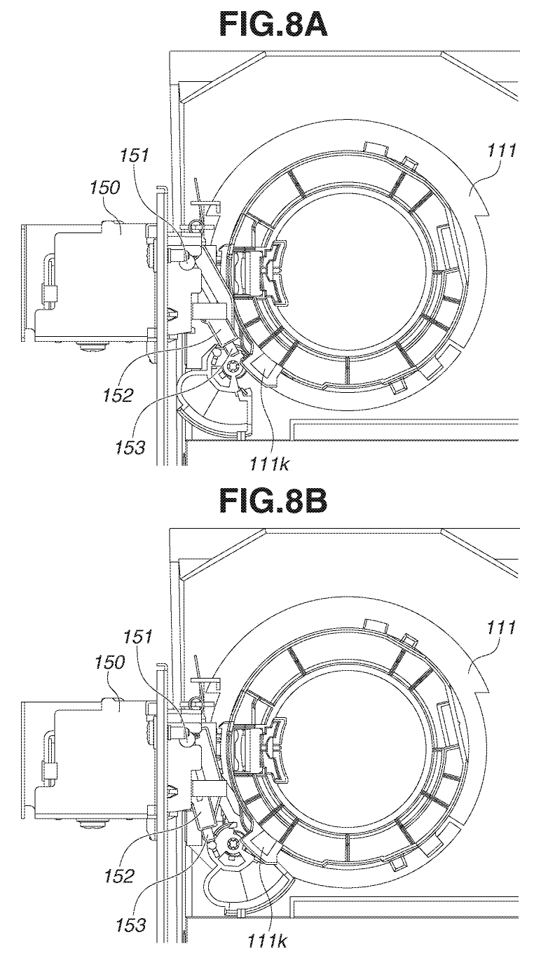

The ring member 111 of the image forming apparatus 1 is locked such that the ring member 111 does not rotate even when the user applies a force thereto in a normal state. FIGS. 8A and 8B are explanatory diagrams each illustrating the lock mechanism that locks the rotation of the ring member 111. FIGS. 8A and 8B each illustrate a view of the toner receiving portion 110 as seen from the inside of the apparatus (toward the Z-direction) so that the example of the configuration in the toner receiving portion 110 can be understood in more detail. The toner receiving portion 110 includes a lock unit 150. The lock unit 150 includes a bar-like lock member 152 that has one end supported by a shaft 151 and is rotatable about the shaft 151. The ring member 111 has a protrusion 111k. In a normal state, a tip end 153 located on an opposite side of the shaft 151 of the lock member 152 is biased in a direction away from the lock unit 150 by an elastic force of a spring (not illustrated) in the lock unit 150, whereby the tip end 153 is positioned on a rotational locus of the protrusion 111k of the ring member 111. Therefore, even if the user attempts to rotate the ring member 111 clockwise in the drawing (in the Rc direction in the drawing), the tip end 153 of the lock member 152 interferes with the protrusion 111k, and the rotation of the ring member 111 is inhibited. In other words, the opening/closing mechanism of the replenishment path is locked in the closed state (see FIG. 8A).

The lock unit 150 further includes a solenoid (not illustrated) to pivot the lock member 152 in a direction opposite to that of the elastic force of the spring. The solenoid is temporarily energized during a period in which the replenishment of toner from the replenishment pack 200 to the image forming apparatus 1 is permitted, and pivots the lock member 152 by an attraction force thereof. When the solenoid is energized and the lock member 152 is pivoted, the tip end 153 of the lock member 152 retracts from the rotational locus of the protrusion 111k of the ring member 111 (see FIG. 8B). As a result, the user can rotate the ring member 111 clockwise in the drawing. In other words, the opening/closing mechanism for the replenishment path is unlocked. Unlocking of the opening/closing mechanism for the replenishment path means that opening of the replenishment path is permitted, thereby enabling a replenishment operation using the replenishment pack 200.

Locking and unlocking of the opening/closing mechanism are controlled by the processing circuit 90. The configuration of the lock mechanism for locking and unlocking the opening/closing mechanism is not limited to the above-described example, and any mechanism such as a mechanical mechanism, an electromagnetic mechanism, an electrical mechanism, or a software mechanism may be employed. Instead of using a solenoid, for example, a motor or any other type of actuator may be used to drive the lock member 152. When an opening/closing mechanism that operates based on computer control without relying on a user operation is employed, locking and unlocking of the opening/closing mechanism may be implemented by a simple program code.

As illustrated in the right figure in FIG. 7, an indicator 125 is disposed in the vicinity of the ring member 111. The indicator 125 indicates a state of the above-described opening/closing mechanism for the user, i.e., whether the opening/closing mechanism is in a locked state or an unlocked state. The indicator 125 includes, for example, an LED disposed in the housing and a window through which light from the LED is transmitted. When the indicator 125 indicates that the opening/closing mechanism is in the unlocked state, the user can rotate the ring member 111 to open the replenishment path.

### Replenishment Management System

### Outline of System

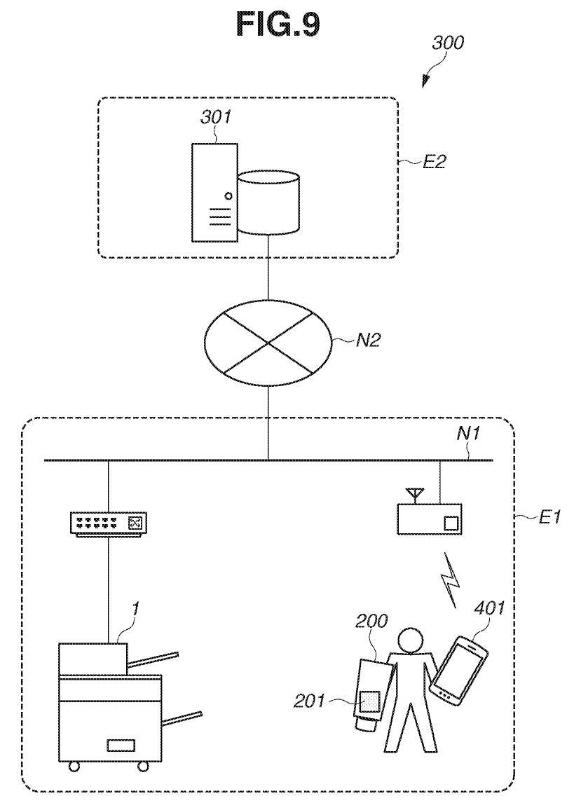

FIG. 9 is a schematic diagram illustrating an example of a configuration of a replenishment management system 300 according to the first embodiment. As illustrated in FIG. 9, the replenishment management system 300 includes the image forming apparatus 1, a management server 301, and a user terminal 401.

The image forming apparatus 1 is installed in a user environment E1 in which the user is present. The user terminal 401 is also present in the user environment E1 and is carried by the user. The image forming apparatus 1 and the user terminal 401 are each connected to a local network N1 that may be, for example, a local area network (LAN). The management server 301 is installed in a remote environment E2. The remote environment E2 is connected to the local network N1 via an external network N2.

The external network N2 may be, for example, the Internet or a virtual private network (VPN). Each of the local network N1 and the external network N2 may include, for example, any type of and any number of network devices such as a router, a switch, a gateway, a wireless access point, and a base station.

In the user environment E1, the user uses the image forming apparatus 1. The image forming apparatus 1 forms an image on the recording medium P with toner as the consumable material as described above. When the toner stored in the image forming apparatus 1 is depleted, the user connects the replenishment pack 200, which is the toner container accommodating toner, to the image forming apparatus 1 to replenish the image forming apparatus 1 with toner from the replenishment pack 200. When the replenishment pack 200 becomes empty and there is no spare replenishment pack 200 in the user environment E1, the image forming apparatus 1 cannot be used when the toner is depleted next time. In the present embodiment, the management server 301 remotely manages a usage status of each of the image forming apparatus 1 and the replenishment pack 200 by each user to avoid such a situation.

The management server 301 is a server apparatus for managing the replenishment of toner from the replenishment pack 200 to the image forming apparatus 1. The management server 301 centrally manages usage statuses of respective image forming apparatuses 1 by a plurality of users. The management server 301 may be implemented as, for example, an application server, a database server, or a cloud server using a high-performance general-purpose computer. The user terminal 401 is a terminal apparatus that provides the user with a user interface for supporting a replenishment management function of the management server 301. The user terminal 401 may be, for example, a general-purpose terminal apparatus such as a smart phone, a mobile phone, a personal computer (PC), or a personal digital assistant (PDA). The image forming apparatus 1 may also provide the user with a user interface.

Functions of the management server 301 to be described in detail below may be provided by a single apparatus, or may be provided by a plurality of physically different apparatuses that cooperate with each other. A part of a database that is described as being held by the management server 301 may be held by another apparatus (e.g., another database server) different from the management server 301.

### Example of Configuration of Management Server

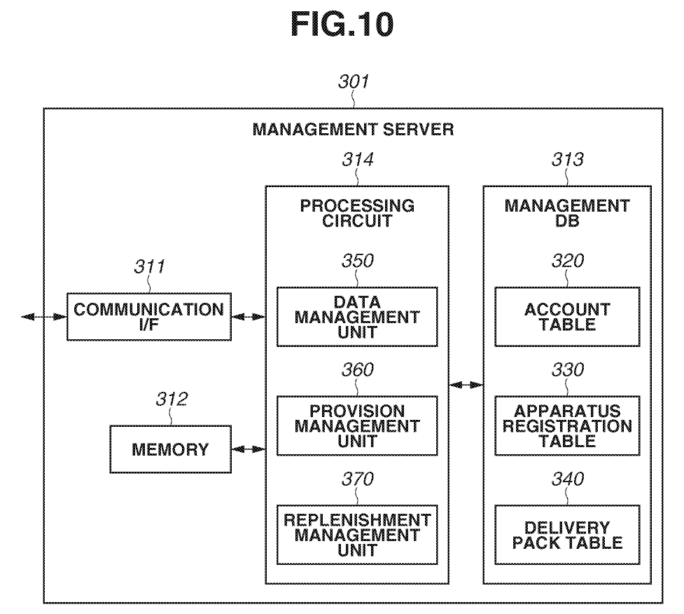

FIG. 10 is a block diagram illustrating an example of a configuration of the management server 301 according to the present embodiment.

As illustrated in FIG. 10, the management server 301 includes a communication interface (I/F) 311, a memory 312, a management database (DB) 313, and a processing circuit 314.

The communication I/F 311 is an interface for the management server 301 to communicate with another apparatus. For example, the communication I/F 311 communicates with the image forming apparatus 1 and the user terminal 401 that are present in the user environment E1. The communication I/F 311 may be a wired communication interface, or may be a wireless communication interface.

The memory 312 may include any type of storage medium such as a semiconductor memory including, for example, a read-only memory (ROM) or a random access memory (RAM), an optical disc, or a magnetic disk. The memory 312 may also include a non-transitory computer-readable storage medium. The memory 312 stores one or more computer programs that are executed by the processing circuit 314, and various data.

The management DB 313 includes a group of tables for managing replenishment of a consumable material to one or more image forming apparatuses under the management of the replenishment management system 300. More specifically, as illustrated in FIG. 10, the management DB 313 includes an account table 320, an apparatus registration table 330, and a delivery pack table 340.

The account table 320 is a table that holds information about an account of a user who uses the replenishment pack 200 provided by the replenishment management system 300. The account table 320 may include, for example, one or more of the following information items:
"User ID"
"Password"
"Name"
"E-mail address"
"Address"
"Contract type"
"Payment information"

The "user ID" indicates identification information for uniquely identifying each user account.

The "password" is used for user authentication when the user logs into the system. The "name" indicates a user name of each account. The user name is displayed, for example, on a screen after login, and may be used as an address for delivery of the replenishment pack 200. The "address" may be used as an address for delivery of the replenishment pack 200. The "e-mail address" may be used when the system sends various notifications to each user by e-mail. The "contract type" indicates the type of contract concluded by each user with a business operator that operates the replenishment management system 300. A provision management unit 360 to be described below may determine when the replenishment pack 200 is to be delivered to each user depending on the contract type of the user. The "payment information" is information about a payment method for the replenishment pack 200 provided to each user.

The apparatus registration table 330 is a table that holds information about the image forming apparatus registered in the replenishment management system 300 as an apparatus of each user. The apparatus registration table 330 includes, for example, one or more of the following information items:
"Owner"
"Apparatus ID"
"Registration date"
"Status"
"Remaining amount of toner"

The "owner" indicates an account of a user who owns or manages each image forming apparatus by the "user ID" registered in the account table 320. The "apparatus ID" is identification information for uniquely identifying each image forming apparatus. A pair of the "owner" and "apparatus ID" indicates association between each user account and at least one image forming apparatus registered as the apparatus of the user having the account. Two or more image forming apparatuses may be associated with one user account. The "registration date" indicates a date when the "apparatus ID" of each image forming apparatus is registered in the apparatus registration table 330. The "status" represents the state of each image forming apparatus. For example, the "status" indicates a status regarding verification as to whether the image forming apparatus is actually installed in the user environment of the "owner". At the time of initial registration of the "apparatus ID", the "status" indicates "not verified", and after the verification is complete, the "status" may be changed to "verified". In addition, as described below, values indicating "replenishment standby", "replenishment appropriate", "replenishment inappropriate", and "re-replenishment standby" can also be added to the "status". The "remaining amount of toner" indicates the latest value of the remaining amount of toner detected and reported by each image forming apparatus. For example, the "remaining amount of toner" is expressed in percentage.

The delivery pack table 340 is a table that holds information about the replenishment pack 200 that has been shipped to each user. The delivery pack table 340 includes, for example, at least one of the following information items:
"Contractor"
"Pack ID"
"Shipping date"
"Status"
"Date of use"
"Toner content"

The "contractor" indicates an account of a user to which each replenishment pack 200 is provided by the "user ID" registered in the account table 320. The "pack ID" is identification information for uniquely identifying each replenishment pack 200. A pair of the "contractor" and "pack ID" indicates association between each user account and at least one replenishment pack 200 provided to the user having the account. Because each user repeatedly consumes toner, the number of replenishment packs 200 associated with one user account in the delivery pack table 340 increases with time. The "shipping date" indicates a date when each replenishment pack 200 is shipped out to the "contractor". The "status" indicates a status as to whether each replenishment pack 200 has been used to replenish the image forming apparatus with toner. At the time of shipment, the "status" indicates "unused". After each replenishment pack 200 reaches the user environment, authentication is completed, and toner replenishment is performed, the "status" may be changed to "used". The "date of use" indicates a date on which each replenishment pack 200 is used for toner replenishment.

The processing circuit 314 may be, for example, a CPU, and may provide various functions of the management server 301 by executing computer programs stored in the memory 312. More specifically, as illustrated in FIG. 10, the processing circuit 314 functions as a data management unit 350, the provision management unit 360, and a replenishment management unit 370.

The data management unit 350 manages registration and update of data in the management DB 313. The data management unit 350 causes the user terminal 401 to display a screen for receiving input of account information to be registered in the account table 320, receives the input account information via the communication I/F 311, and registers the received information in the account table 320. Similarly, the data management unit 350 causes the user terminal 401 to display a screen for receiving input of apparatus information about the image forming apparatus owned by each user, receives the input apparatus information via the communication I/F 311, and registers the received information in the apparatus registration table 330. Such input screens may be provided in any form such as a webpage, an input form, or an application screen. Typically, reception of the input apparatus information is performed during a period in which user authentication using a user ID and a password stored in the account table 320 is successful and the user has logged in to the system.

The data management unit 350 performs a simple verification as to whether an apparatus corresponding to the apparatus information registered in the apparatus registration table 330 is actually installed in the user environment of the corresponding user. For example, in a case where the user has logged in to the system and has input apparatus information about the image forming apparatus 1 on an input screen, the data management unit 350 presents a message that prompts the user to perform a predetermined operation on the image forming apparatus 1 to the user. Examples of the predetermined operation include pressing of a specific physical button on the image forming apparatus 1, or touching of a button on a graphical user interface (GUI). In addition, in preparation for a case where a power supply of the image forming apparatus 1 is turned off, a notification indicating that the image forming apparatus 1 is to be turned on may also be issued. When the user performs the operations as prompted on the image forming apparatus 1, the image forming apparatus 1 transmits the apparatus ID identifying the image forming apparatus 1 to the management server 301. The data management unit 350 waits for reception of the apparatus ID from the image forming apparatus 1 until a predetermined period has elapsed from presentation of the above-described message. Then, in a case where the apparatus ID the same as the apparatus ID input by the user is received from the image forming apparatus 1 before timeout, the data management unit 350 determines that the image forming apparatus 1 identified by the apparatus ID is actually installed in the user environment. The data management unit 350 sets the value of the "status" in the apparatus registration table 330 for the apparatus before completion of such verification to "not verified", and sets the value of the "status" in the apparatus registration table 330 for the apparatus after completion of the verification to "verified".

In the present embodiment, the data management unit 350 also manages updates on the value of the "remaining amount of toner" in the apparatus registration table 330. The data management unit 350 receives remaining amount information regarding the remaining amount of consumable material in the storage portion 48 of the image forming apparatus 1 from the registered image forming apparatus 1 via the communication I/F 311. Then, the data management unit 350 updates the status information regarding the remaining amount of consumable material, i.e., the value of the "remaining amount of toner" in the apparatus registration table 330, based on the received remaining amount information.

The provision management unit 360 manages provision of the replenishment pack 200 to the user of the replenishment management system 300. For example, the provision management unit 360 monitors an occurrence of a trigger event that triggers the provision of the replenishment pack 200 to the user.

An example of the trigger event is a purchase of the replenishment pack 200 by the user. The provision management unit 360 starts the provision of the replenishment pack 200 to a user who is a purchaser when, for example, an order for the replenishment pack 200 is received (i.e., when an individual contract is concluded) on a website that sells consumable materials for image formation. In the present embodiment, the toner content (also referred to as a filling amount) of the replenishment pack 200 to be provided to the user is 70 g.

Another example of the trigger event is an arrival of a provision timing based on the contract with the user. For example, it is assumed that a certain user has concluded a periodic purchase contract with the business operator to periodically purchase a predetermined number of replenishment packs 200 (e.g., once a month or once every several months). For such a user, when it is determined that the next provision timing for the replenishment pack 200 has arrived, the provision management unit 360 starts the provision of the replenishment pack 200 to the user.

Yet another example of the trigger event may be detection of a decrease in the remaining amount of toner in the image forming apparatus 1 registered in the apparatus registration table 330. For example, it is assumed that a certain user has concluded an automatic purchase contract with the business operator to automatically receive provision of a new replenishment pack 200 when the remaining amount of toner in the image forming apparatus 1 owned by the user decreases. In this case, the provision management unit 360 may monitor the value of the "remaining amount of toner" in the apparatus registration table 330 for the registered image forming apparatus 1 of the user, and may start the provision of the replenishment pack 200 to the user when it is determined that the remaining amount of toner is less than a predetermined threshold. Additionally or alternatively, the trigger event for the automatic purchase of the replenishment pack 200 may be reaching a threshold of the number of times of operation on the registered image forming apparatus 1 (e.g., the number of times of job execution or the cumulative number of consumed sheets of recording media). Additionally or alternatively, the trigger event for the automatic purchase of the replenishment pack 200 may be detection of use of the replenishment pack 200 previously provided to the user. For example, the provision management unit 360 monitors the "status" in the delivery pack table 340 for the replenishment pack 200 that has been provided to the user who has concluded the automatic purchase contract, and when the value of the "status" is changed from "unused" to "used", the provision management unit 360 starts the provision of the replenishment pack 200.

The periodical or automatic provision of the new replenishment pack 200 to the user in accordance with detection of such trigger events makes it possible to reduce the possibility that the image forming apparatus 1 cannot be used due to depletion of the consumable material at a timing unexpected by the user.

The provision management unit 360 can determine which one of the above-described trigger events is to be monitored for each user based on the content of the "contract type" in the account table 320. When the provision management unit 360 determines that the trigger event has occurred for a certain user, the provision management unit 360 allocates a new replenishment pack 200 to the user and sends, to a delivery person in charge, a message instructing delivery of the allocated replenishment pack 200. In addition, the provision management unit 360 adds, to the delivery pack table 340, a new record indicating the user ID of the delivery-destination user and the pack ID identifying the allocated replenishment pack 200, and registers an association between the user account and the replenishment pack 200 in the management DB 313. The "shipping date" in the delivery pack table 340 may be set to a date on which the replenishment pack 200 is shipped, and the "status" and the "date of use" may be set, as initial values, to "unused" and a blank field, respectively.

As described above, at least one of the replenishment pack 200 and the image forming apparatus 1 includes the opening/closing mechanism capable of opening and closing the consumable material replenishment path. The opening/closing mechanism is locked by the lock mechanism so as to prevent the opening/closing mechanism from being opened in a normal state. The replenishment management unit 370 receives a result indicating that the replenishment pack 200 has been shipped to the user, and transmits an unlock instruction to the image forming apparatus 1 via the communication I/F 311, thereby enabling the image forming apparatus 1 to open the replenishment path by the opening/closing mechanism. In addition, in the image forming apparatus 1, when the opening/closing mechanism operates based on computer control without relying on a user operation, the replenishment management unit 370 may cause the opening/closing mechanism of the image forming apparatus 1 to open the consumable material replenishment path, instead of unlocking the opening/closing mechanism. The unlock instruction (or an opening instruction) for the image forming apparatus 1 may be transmitted directly to the image forming apparatus 1 from the management server 301.

When the opening/closing mechanism is unlocked, the replenishment path is opened, and the image forming apparatus 1 is replenished with toner from the replenishment pack 200, the remaining amount of toner in the storage portion 48 of the image forming apparatus 1 increases. As described below, the image forming apparatus 1 detects the remaining amount of toner in the storage portion 48 and transmits the remaining amount information to the management server 301. The data management unit 350 receives the remaining amount information via the communication I/F 311 and updates the value of the "remaining amount of toner" in the apparatus registration table 330. When the received remaining amount information indicates an increase in the remaining amount of toner, the data management unit 350 changes the "status" for the replenishment pack 200 in the delivery pack table 340 to "used". Thus, when the same replenishment pack 200 is thereafter attempted to be reused, the replenishment management unit 370 can, based on the status information, not permit reuse of the replenishment pack 200. In addition, the provision management unit 360 can allocate a new replenishment pack 200 to the user in accordance with detection of use of the replenishment pack 200.

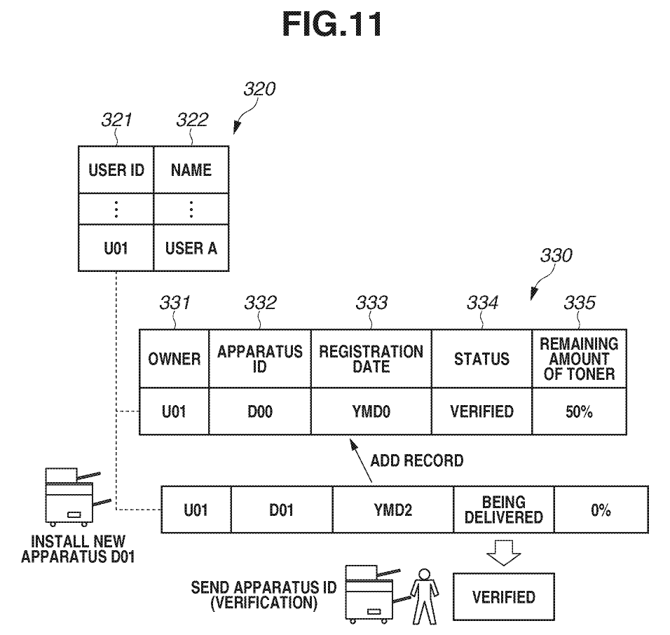

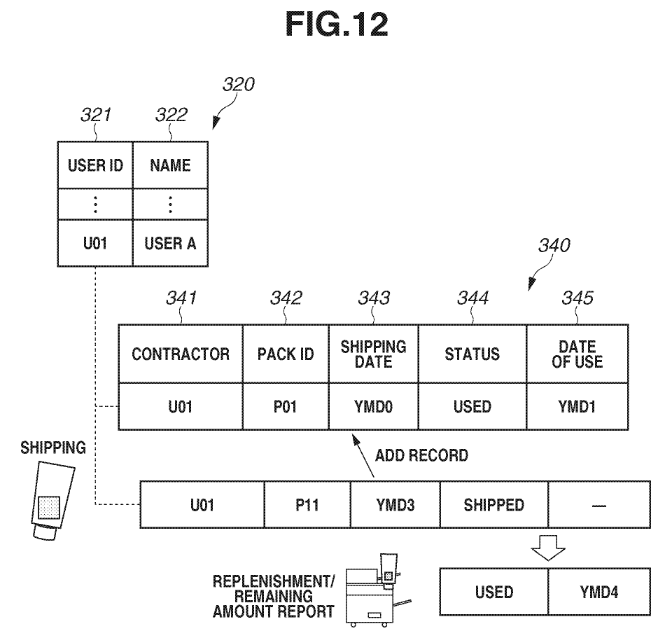

Updating contents of the management DB 313 will be described below with reference to FIGS. 11 and 12. FIG. 11 illustrates an example of updating the apparatus registration table 330 during apparatus registration. In an upper part of FIG. 11, the account table 320 including, as data items, a user ID 321 and a name 322 is illustrated. The other data items in the account table 320 are omitted in FIG. 11. In a middle part of FIG. 11, the apparatus registration table 330 including, as data items, an owner 331, an apparatus ID 332, a registration date 333, a status 334, and a remaining amount of toner 335 is illustrated. In the example illustrated in FIG. 11, an account of a user identified by a user ID "U01" (hereinafter referred to as a user U01) is already registered in the account table 320. An image forming apparatus identified by an apparatus ID "D00" is already registered as the apparatus of the user U01 in the apparatus registration table 330.

The user U01 newly installs an image forming apparatus identified by an apparatus ID "D01" (hereinafter referred to as an apparatus D01) in the user environment E1. When the user U01 inputs apparatus information about the apparatus D01 via an input screen provided by the management server 301, the management server 301 adds a record for the apparatus information about the apparatus D01 to the apparatus registration table 330. In the added record, the owner 331 indicates "U01", the apparatus ID 332 indicates "D01", the registration date 333 indicates the date on which the registration is performed, the status 334 indicates "not verified", and the remaining amount of toner 335 indicates "0%".

Further, the user U01 performs an operation for apparatus registration on the newly installed apparatus D01, for example, in accordance with a message displayed on the screen. The apparatus D01 stores the apparatus ID "D01" of the apparatus D01 in advance, and sends the apparatus information including the apparatus ID to the management server 301 in response to a user operation. If the received apparatus ID matches the apparatus ID input by the user U01, the data management unit 350 changes the value of the status 334 in the record added to the apparatus registration table 330 from "not verified" to "verified" as illustrated in a lower part of FIG. 11.

FIG. 12 illustrates an example of updating the delivery pack table 340 during pack delivery. In an upper part of FIG. 12, contents of the account table 320 similar to that in FIG. 11 are illustrated. In a middle part of FIG. 12, the delivery pack table 340 including, as data items, a contractor 341, a pack ID 342, a shipping date 343, a status 344, and a date of use 345 is illustrated. In the example illustrated in FIG. 12, the replenishment pack 200 identified by a pack ID "P01" has already been provided to the user U01, and the replenishment pack 200 is "used".

The provision management unit 360 allocates a new replenishment pack (hereinafter referred to as a replenishment pack P11) identified by a pack ID "P11" to the user U01 in accordance with detection of one of the above-described trigger events. Further, the provision management unit 360 adds a record for managing a status of the allocated replenishment pack P11 to the delivery pack table 340. In the added record, the contractor 341 indicates "U01", the pack ID 342 indicates "P11", the shipping date 343 indicates the date on which the replenishment pack is shipped, the status 344 indicates "shipped", and the date of use 345 is a blank field.

When the replenishment pack P11 reaches the user environment and the apparatus to be replenished is replenished with toner, the apparatus to be replenished sends a report indicating an increase in the remaining amount of toner to the management server 301. Based on the report, the data management unit 350 changes the value of the status 344 in the record added to the delivery pack table 340 from "shipped" to "used", and adds the date on which the report indicating the increase in the remaining amount of toner is sent to the date of use 345.

### Example of Configuration of Image Forming Apparatus

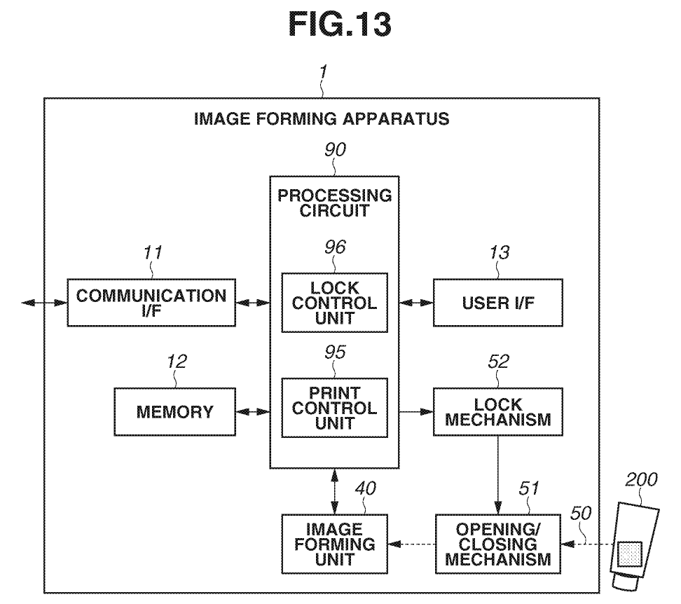

FIG. 13 is a block diagram illustrating an example of a functional configuration of the image forming apparatus 1 according to the present embodiment. As illustrated in FIG. 13, the image forming apparatus 1 includes a communication I/F 11, a memory 12, a user I/F 13, the image forming unit 40, an opening/closing mechanism 51, a lock mechanism 52, and the processing circuit 90.

The communication I/F 11 is an interface for the image forming apparatus 1 to communicate with another apparatus. The communication I/F 11 communicates with the user terminal 401 that is present in the user environment E1 and the management server 301 that is present in the remote environment E2. The communication I/F 11 may be a wired communication interface, or may be a wireless communication interface. When the communication I/F 11 is a wireless communication interface, the communication I/F 11 may be, for example, a wireless LAN (WLAN) interface or a cellular communication interface. While FIG. 13 illustrates only a single communication I/F 11, the image forming apparatus 1 may include a plurality of different communication modules for communicating with the user terminal 401 and the management server 301.

The memory 12 stores one or more computer programs to be executed by the processing circuit 90, and various data. The memory 12 stores, for example, an apparatus ID (also referred to as apparatus identification information) for uniquely identifying the image forming apparatus 1 in advance. The memory 12 may include any type of storage medium such as a semiconductor memory such as a ROM or a RAM, an optical disc, or a magnetic disk. The memory 12 may also include a non-transitory computer-readable storage medium.

The user I/F 13 includes an input device for receiving an operation and information input by the user, and a display device for displaying an image and information. For example, the user I/F 13 may include one or more of a touch panel, a keypad, a button, a switch, a microphone, and a speaker. The user I/F 13 may be treated as an operation terminal integrated with the image forming apparatus 1.

The image forming unit 40 forms an image on a recording medium such as a sheet by consuming toner stored in the storage portion 48 as described with reference to FIG. 2. The opening/closing mechanism 51 is a mechanism capable of opening and closing a replenishment path 50 from the replenishment pack 200 connected to the toner receiving portion 110 to the storage portion 48. The ring member 111 including the lever 111b and the projection 111d, the pack shutter 214 of the replenishment pack 200, and the main body shutter 116 described above are examples of the opening/closing mechanism 51.

The lock mechanism 52 is a mechanism for inhibiting (i.e., locking) an operation of the opening/closing mechanism 51 by the user or an automatic actuation of the opening/closing mechanism 51, and for releasing the inhibition (unlocking). The above-described lock unit 150 is an example of the lock mechanism 52.

The above-described group of electronic components 91, 92, and 93 in the processing circuit 90 may mainly function as a print control unit 95 and a lock control unit 96 from a functional perspective. The print control unit 95 controls the operation for image formation by the image forming unit 40. For example, when a print job is received from an external apparatus via the communication I/F 11, the print control unit 95 controls the image forming unit 40 to form an image based on input image data included in the print job on a recording medium.

Upon reception of an unlock instruction, the lock control unit 96 causes the lock mechanism 52 to unlock the opening/closing mechanism 51 in accordance with the unlock instruction. For example, the lock control unit 96 may energize the solenoid of the lock unit 150 to rotate the lock member 152 as in the example illustrated in FIG. 8B. This enables the user to rotate the main body shutter 116 and the pack shutter 214 of the replenishment pack 200 together with the ring member 111 to open the replenishment path 50. When a mechanism in which the opening/closing mechanism 51 is automatically actuated by the image forming apparatus 1 is employed, the lock control unit 96 may wait for reception of an opening instruction instead of the unlock instruction, and may operate the opening/closing mechanism 51 according to the received opening instruction to thereby open the replenishment path 50.

In a case where the image formation operation is performed and replenishing of a consumable material is performed, the print control unit 95 controls the remaining amount detection unit 61 to detect the remaining amount of toner in the storage portion 48. The remaining amount detection unit 61 causes the light emitter 61a to emit light and acquires a photodetection signal from the light receiver 61b while toner stored in the storage portion 48 is being agitated by the agitation member 60. Then, the remaining amount detection unit 61 estimates the remaining amount of toner based on the acquired photodetection signal, and sends a report indicating the estimated remaining amount of toner to the print control unit 95. The print control unit 95 sends a report (notification) about the remaining amount information indicating the detected remaining amount of toner to the management server 301 via the communication I/F 11.

When the toner replenishment is performed, the remaining amount of toner increases. The management server 301 detects an increase in the remaining amount of toner based on the remaining amount information as described above, thereby ascertains that the shipped replenishment pack 200 has been used by the user. Instead of the management server 301, the image forming apparatus 1 may detect an increase in the remaining amount of toner and may send a notification signal indicating that the replenishment pack 200 has been used to the management server 301.

### Replenishment Management Processing Flow

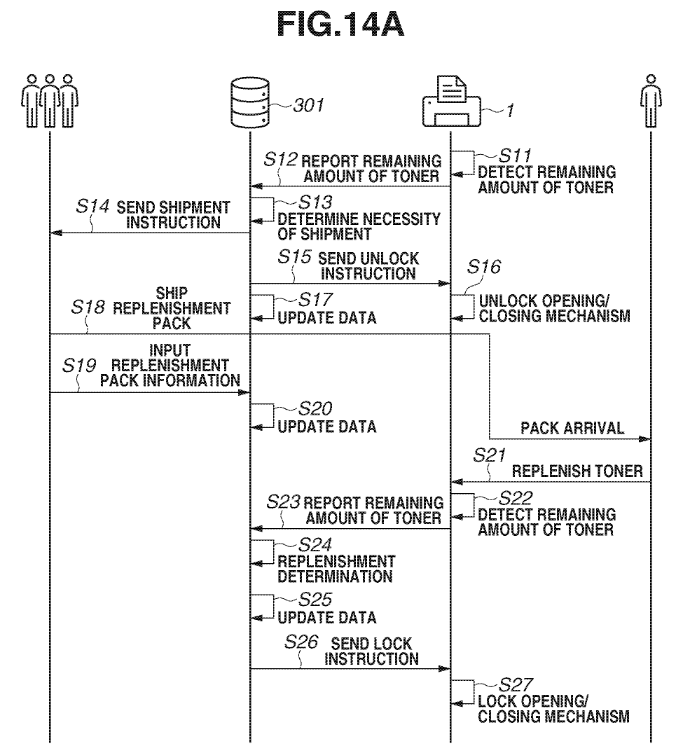

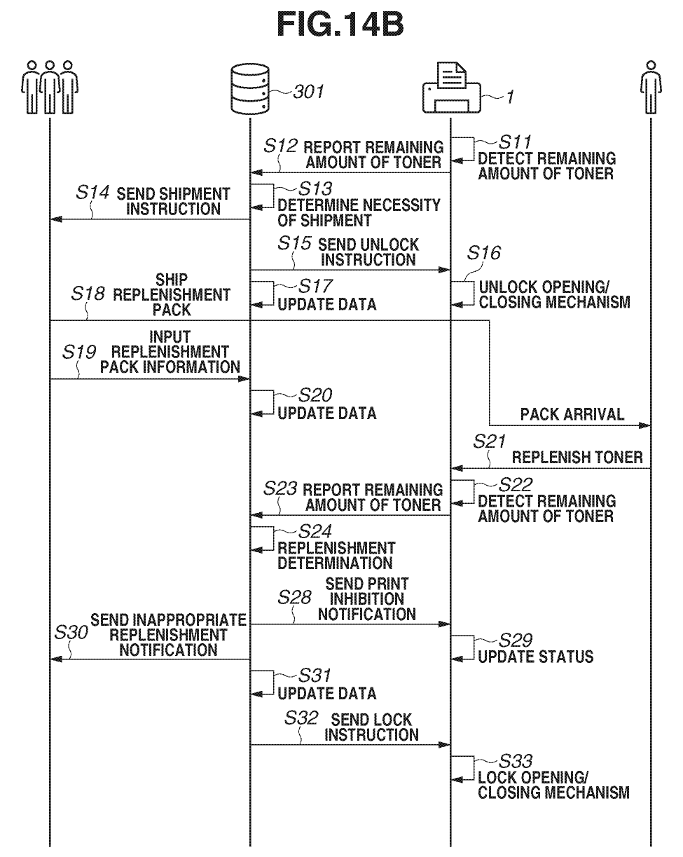

Next, a flow of processing that can be executed during replenishment management according to features of the present embodiment will be described with reference to sequence diagrams illustrated in FIGS. 14A and 14B. In the following description, each processing step is abbreviated as "S". A series of processes during the replenishment management described with reference to FIGS. 14A and 14B assists the user in performing toner replenishment to the image forming apparatus 1 using a genuine replenishment pack provided to the user. Further, the replenishment management system 300 is provided that is capable of preventing the user from being subjected to such a phenomenon as a failure, a malfunction, or degradation in image quality of the image forming apparatus 1, or depletion of toner at an unexpected timing.

The sequence diagrams illustrated in FIGS. 14A and 14B are mainly executed by the image forming apparatus 1 and the management server 301 that are components of the system according to the present embodiment. The provision management unit 360 of the management server 301 continuously monitors occurrence of the trigger event that triggers the provision of the replenishment pack 200 to the user. Here, an arrival of the provision timing based on a decrease in the remaining amount of toner will be described as an example of the trigger event.

FIG. 14A is a sequence diagram illustrating a flow of processing of an example including the provision of the replenishment pack 200 and the replenishment in a case where it is determined that the replenishment is appropriate in replenishment determination in step S24 to be described below. FIG. 14B is a sequence diagram illustrating a flow of processing of an example including the provision of the replenishment pack 200 and the replenishment in a case where it is determined that the replenishment in step S21 is inappropriate in the replenishment determination in step S24 to be described below. First, the sequence diagram of FIG. 14A will be described.

As in FIG. 14A, in step S11, the print control unit 95 of the image forming apparatus 1 detects the remaining amount of toner in the storage portion 48. As a timing for detecting the remaining amount of toner, for example, the remaining amount of toner is detected when the image formation operation is performed or the like. Assume herein that the remaining amount of toner is less than a remaining amount threshold for triggering the provision of a new replenishment pack 200.

In step S12, the print control unit 95 transmits remaining amount information indicating the detected remaining amount of toner to the management server 301. In step S13, the provision management unit 360 of the management server 301 that has received the notification about the remaining amount of toner from the print control unit 95 recognizes that the remaining amount of toner in the image forming apparatus 1 has decreased. Then, the provision management unit 360 determines that there is a necessity to ship a new replenishment pack 200. In step S14, the provision management unit 360 sends, to the person in charge of delivery, a message to instruct delivery of the new replenishment pack 200 to the user.

In step S15, the replenishment management unit 370 of the management server 301, in response to determination to ship the new replenishment pack 200 in step S13, sends the unlock instruction for causing the lock mechanism 52 of the image forming apparatus 1 to unlock the opening/closing mechanism 51 to the image forming apparatus 1.

In step S16, the lock control unit 96 of the image forming apparatus 1 causes the lock mechanism 52 to unlock the opening/closing mechanism 51 in response to reception of the unlock instruction from the management server 301.

In step S17, the data management unit 350 of the management server 301 updates the status 334 in the apparatus registration table 330 to "replenishment standby", and further updates the remaining amount of toner 335 to the value of the remaining amount information notified in step S12.

In step S18, the new replenishment pack 200 is shipped to the user from the person in charge of delivery. In step S19, information about the shipped replenishment pack 200 is input to the management server 301 by the person in charge of delivery.

In step S20, the data management unit 350 updates the pack ID 342 and the shipping date 343 in the delivery pack table 340 based on the information input in step S19.

In step S21, the unlocked opening/closing mechanism 51 is operated by the user (or automatically operated) to open the replenishment path 50, and the image forming apparatus 1 is replenished with the consumable material from the replenishment pack 200.

In step S22, the print control unit 95 detects the remaining amount of toner in the storage portion 48. In step S23, the print control unit 95 notifies the management server 301 of remaining amount information indicating the detected remaining amount of toner. In step S24, the replenishment management unit 370 of the management server 301 determines whether the replenishment in step S21 has been appropriately executed. If it is determined that the replenishment has been appropriate in step S24, in step S25, the data management unit 350 updates the value of the status 334 in the apparatus registration table 330 to "replenishment appropriate". Then, the data management unit 350 updates the remaining amount of toner 335 with the information about the remaining amount of toner received in step S23. Further, the data management unit 350 updates the status 344 in the delivery pack table 340 to "used".

In step S26, the replenishment management unit 370 sends, to the image forming apparatus 1, a lock instruction for causing the lock mechanism 52 of the image forming apparatus 1 to lock the opening/closing mechanism 51. Lastly, in step S27, the lock control unit 96 of the image forming apparatus 1 causes the lock mechanism 52 to lock the opening/closing mechanism 51 again in response to reception of the lock instruction from the management server 301, and then the flow of the series of processes ends.

On the other hand, a sequence diagram when it is determined that the replenishment in step S21 has been inappropriate in the replenishment determination in step S24 will be described with reference to FIG. 14B. Steps S11 to S23 are similar to those in FIG. 14A, and thus description thereof is omitted.

If it is determined that the replenishment has been inappropriate in step S24, in step S28, the replenishment management unit 370 sends a print inhibition notification to the image forming apparatus 1. In step S29, the print control unit 95 of the image forming apparatus 1 receives the print inhibition notification and transitions to a state where printing is not performed even when a print instruction is received from the user.

In step S30, the replenishment management unit 370 notifies the person in charge of delivery or another service administrator that an inappropriate replenishment has occurred. In step S31, the data management unit 350 updates the status 334 in the apparatus registration table 330 to "replenishment inappropriate", and updates the status 344 in the delivery pack table 340 to "unknown".

In step S32, the replenishment management unit 370 sends, to the image forming apparatus 1, a lock instruction for causing the lock mechanism 52 of the image forming apparatus 1 to lock the opening/closing mechanism 51.

Lastly, in step S33, the lock control unit 96 of the image forming apparatus 1 causes the lock mechanism 52 to lock the opening/closing mechanism 51 again in response to reception of the lock instruction from the management server 301, and then the flow of the series of processes ends. Note that the opening/closing mechanism 51 is locked in step S33 to prevent further inappropriate replenishment to the image forming apparatus 1 from being performed. However, if there is no need to lock, this process may be omitted.

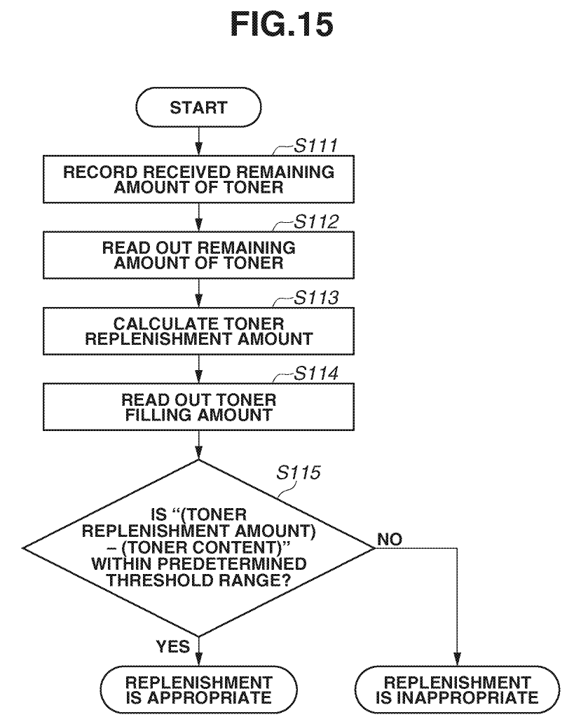

Next, processing of the replenishment determination in step S24 according to the present embodiment will be described in more detail with reference to FIG. 15. FIG. 15 is a flowchart illustrating a flow of processing in the management server 301 related to the replenishment determination in step S24. Each step in the flowchart of FIG. 15 is executed by the processing circuit 314 of the management server 301.

As illustrated in FIG. 15, first, in step S111, the data management unit 350 records the remaining amount of toner after replenishment, received from the image forming apparatus 1. Next, in step S112, the replenishment management unit 370 reads out the remaining amount of toner before replenishment recorded in the data management unit 350.

In step S113, the replenishment management unit 370 calculates a difference between the remaining amount of toner after replenishment read in step S111 and the remaining amount of toner before replenishment read in step S112, and calculates a toner replenishment amount. In other words, the toner replenishment amount is calculated based on information about the remaining amount of toner before and after replenishment.

In step S114, the toner content of the shipped replenishment pack 200 recorded in the data management unit 350 is read out. In the example of the present embodiment, the toner content of the delivered replenishment pack 200 is 70 g as an example; however, in recent years, a plurality of types and sizes of replenishment packs have been delivered, and thus information about the toner content corresponding to a type and size of the delivered replenishment pack is read out in this case.

In step S115, the replenishment management unit 370 determines whether a difference between the toner replenishment amount calculated in step S113 and the toner content of the shipped replenishment pack 200 read out in step S114 is within a predetermined threshold range. If the difference is within the predetermined threshold range (YES in step S115), it is likely that the toner replenishment has been executed using the shipped replenishment pack 200. Therefore, it is determined that the replenishment is appropriate, and then the series of processes of the replenishment determination ends.

On the other hand, in step S115, if the difference between the toner replenishment amount calculated in step S113 and the toner content of the shipped replenishment pack 200 read in step S114 is out of the predetermined threshold range, the replenishment management unit 370 determines that the replenishment is inappropriate, and the series of processes of the replenishment determination ends. The reason why it is determined that the replenishment is inappropriate is that there is a possibility that the replenishment has been executed using a replenishment pack different from the shipped replenishment pack 200. There is another possibility that, even though the replenishment has been executed using the shipped replenishment pack 200, the user has terminated the replenishment operation before all the toner in the replenishment pack 200 is replenished.

The toner replenishment amount calculated in step S113 may include, as an error, variation in detection of the remaining amount of toner by the remaining amount detection unit 61. The toner content read out in step S114 may include, as an error, variation in the toner content of the replenishment pack 200 during production of the replenishment pack 200. Therefore, the predetermined threshold range used for replenishment determination can be determined in consideration of these assumed errors. The present embodiment is described using an example where the replenishment pack 200 has the toner content of 70 g. Accordingly, in consideration of the errors described above, the predetermined threshold range for "(toner replenishment amount) - (toner content)", which is the difference between the toner replenishment amount calculated in step S113 to be used for replenishment determination and the toner content of the shipped replenishment pack 200 read out in step S114, is set to a range from -7 g to 7 g.

According to the present embodiment, as described with reference to FIG. 15, the toner content of the shipped replenishment pack 200 is compared with the toner replenishment amount actually replenished in the image forming apparatus 1. Consequently, it is possible to determine whether toner replenishment to the image forming apparatus 1 has been appropriately performed even without a user operation such as authentication of the replenishment pack 200. Further, as described with reference to FIGS. 14A and 14B, if it is determined that the replenishment has been inappropriate, printing on the image forming apparatus 1 is inhibited. This makes it possible to prevent adverse effects on the user due to a phenomenon such as a failure, a malfunction, or deterioration in image quality caused by the user continuing to use the image forming apparatus 1, or depletion of consumables at an unexpected timing.

Further, by notifying a person in charge of replenishment management that inappropriate replenishment has occurred, the person in charge of replenishment management can contact the user and assist in recovery of the image forming apparatus 1. The image forming apparatus 1 that has received a print inhibition notification may notify the user of a state where the replenishment is inappropriate and printing is inhibited.

In the present embodiment, an example where the replenishment pack 200 has the toner content of 70 g has been described. However, in practice, a plurality of sizes of replenishment packs with different toner contents is prepared in many cases. In such cases, a predetermined threshold range to be used for replenishment determination is to be set in accordance with the toner content of each replenishment pack.

### Second Embodiment

Next, a second embodiment will be described. In the second embodiment, a part of the processing of the replenishment determination according to the first embodiment is changed. Along with a change in the processing of the replenishment determination, a flow of the processing to be executed during replenishment management may be different from that in the first embodiment. Other configurations and processes are similar to those of the first embodiment, and thus description thereof is omitted.

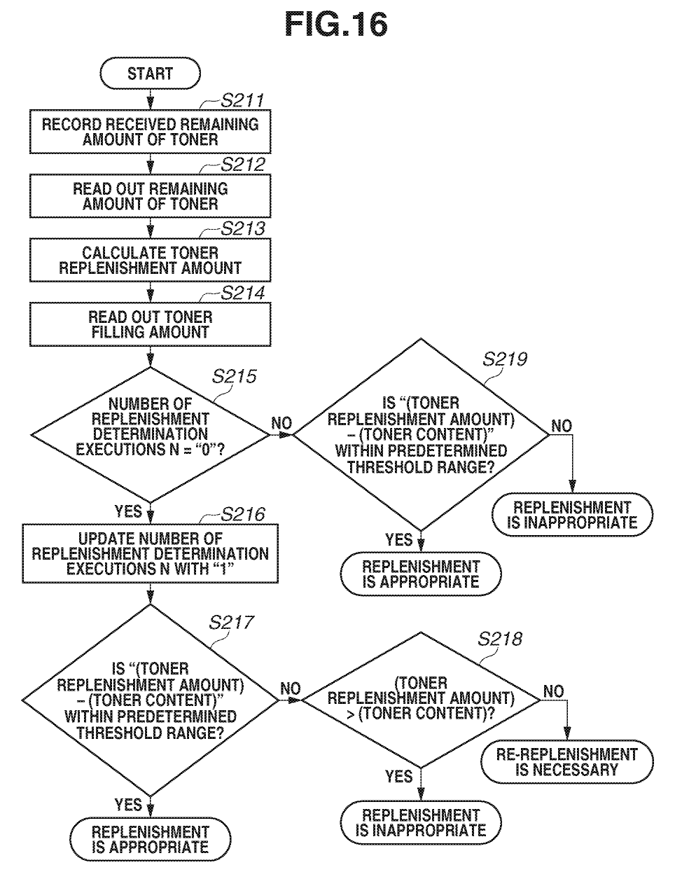

First, the processing of the replenishment determination according to the second embodiment will be described with reference to a flowchart illustrated in FIG. 16.

As in FIG. 15, FIG. 16 is a flowchart illustrating a flow of processing in the management server 301 related to the replenishment determination. Each step in the flowchart of FIG. 16 is executed by the processing circuit 314 of the management server 301. Processing in steps S211 to S214 is similar to the processing in steps S111 to S114 according to the first embodiment, respectively, and thus description thereof is omitted.

In step S215, the replenishment management unit 370 determines whether the number of replenishment determination executions N is 0. Here, the number of replenishment determination executions N is a value indicating how many times the replenishment determination has been executed so far, and an initial value thereof is 0.

In step S215, if it is determined that the number of replenishment determination executions N is 0 (YES in step S215), the processing proceeds to step S216. In step S216, the number of replenishment determination executions N is updated to 1.

In step S217, the replenishment management unit 370 determines whether the toner replenishment amount calculated in step S213 is equivalent to the toner content of the shipped replenishment pack 200 read out in step S214. Specifically, if a difference between the toner replenishment amount calculated in step S213 and the toner content of the shipped replenishment pack 200 read out in step S214 is within the predetermined threshold range, it is determined that the toner replenishment amount calculated in step S213 is equivalent to the toner content of the shipped replenishment pack 200 read out in step S214.

In step S217, if the toner replenishment amount calculated in step S213 is equivalent to the toner content of the shipped replenishment pack 200 read out in step S214 (YES in step S217), it is likely that the replenishment has been executed using the shipped replenishment pack 200. Therefore, the replenishment management unit 370 determines that the replenishment has been appropriate, and the series of processes of the replenishment determination ends.

In step S217, if the toner replenishment amount calculated in step S213 is not equivalent to the toner content of the shipped replenishment pack 200 read out in step S214 (NO in step S217), the processing proceeds to step S218.

In step S218, the toner replenishment amount calculated in step S213 is compared with the toner content of the shipped replenishment pack 200 read out in step S214. If the toner replenishment amount calculated in step S213 is greater than the toner content of the shipped replenishment pack 200 read out in step S214, it is likely that the replenishment has been executed using a replenishment pack different from the shipped replenishment pack 200. Therefore, it is determined that the replenishment is inappropriate, and the series of processes of the replenishment determination ends.

If the determination in step S218 is "NO", it can be determined that the toner content of the shipped replenishment pack 200 read out in step S214 is greater than the toner replenishment amount calculated in step S213. In this case, it is determined that replenishing toner again using the shipped replenishment pack 200 is necessary, and then the series of processes of the replenishment determination ends. The reason why it is determined that re-replenishment is necessary is that, when the toner content of the shipped replenishment pack 200 is greater, there is a possibility that, even though replenishment has been performed, the user has terminated the replenishment operation before all the toner is replenished.

In step S215, if it is determined that the number of replenishment determination executions N is not 0 (NO in step S215), the processing proceeds to step S219. Here, in step S215, it is determined that the number of replenishment determination executions N is not 0 in a case where it is determined that re-replenishment is necessary in step S218 and the re-replenishing is performed by the user.

The processing of step S219 is similar to the processing of step S217, and thus description thereof is omitted.

In step S219, if the toner replenishment amount calculated in step S213 is equivalent to the toner content of the shipped replenishment pack 200 read out in step S214, it is likely that all the toner in the shipped replenishment pack 200 has been replenished to the image forming apparatus 1 by re-replenishment. Therefore, it is determined that the replenishment is appropriate, and the series of processes of the replenishment determination ends.

In step S218, if the toner replenishment calculated in step S213 is not equivalent to the toner content of the shipped replenishment pack 200 read out in step S214, it is likely that the replenishment has been executed using a replenishment pack different from the shipped replenishment pack 200. Therefore, it is determined that the replenishment is inappropriate, and the series of processes of the replenishment determination ends.

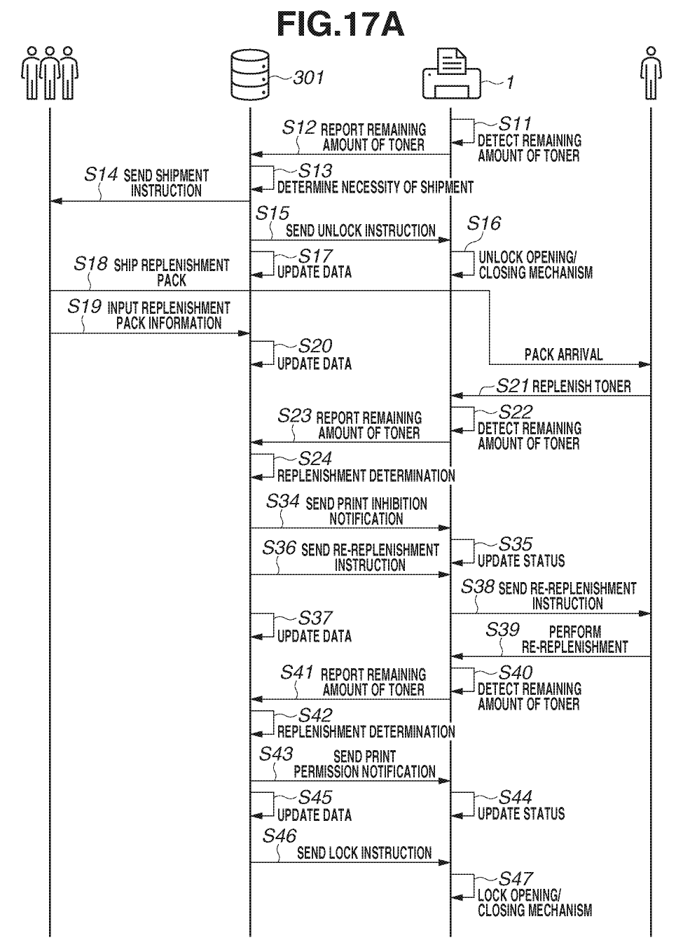

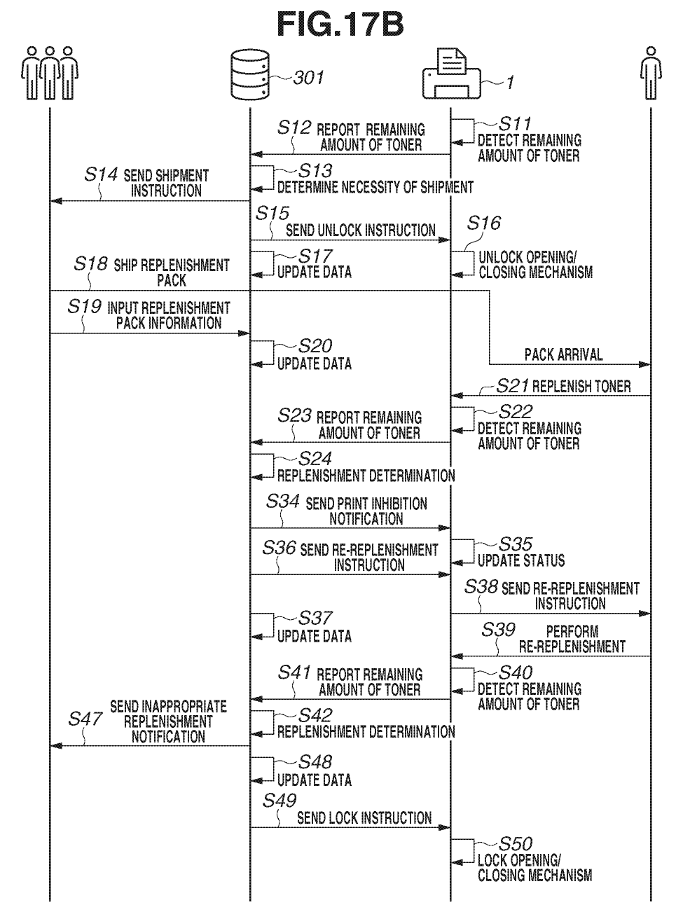

Next, a flow of processing that can be executed during replenishment management will be described with reference to sequence diagrams of FIGS. 17A and 17B. The sequence diagram of FIG. 17A illustrates a flow of processing executed during replenishment management in a case where it is determined in step S218 of FIG. 16 that the re-replenishment is necessary and where it is determined in step S219 that the replenishment is appropriate. Since steps S11 to S24 are similar to those in FIG. 14A, description thereof is omitted.

In step S24, if it is determined that re-replenishment is necessary, in step S34, the replenishment management unit 370 sends a print inhibition notification to the image forming apparatus 1. In step S35, the print control unit 95 of the image forming apparatus 1 receives the print inhibition notification and transitions to a state where printing is not performed even when a print instruction is received from the user. In step S36, the management server 301 sends a re-replenishment instruction to the image forming apparatus 1. In step S37, the data management unit 350 updates the status 334 in the apparatus registration table 330 to "re-replenishment standby" and updates the status 344 in the delivery pack table 340 to "re-replenishment standby".

In step S38, the user I/F 13 of the image forming apparatus 1 sends a re-replenishment instruction to the user.

In step S39, the user performs re-replenishment.

In step S40, the print control unit 95 detects the remaining amount of toner in the storage portion 48. In step S41, the print control unit 95 notifies the management server 301 of the remaining amount information indicating the detected remaining amount of toner. In step S42, the replenishment management unit 370 of the management server 301 determines whether the replenishment has been executed appropriately in step S41.

If it is determined that the replenishment is appropriate in step S42, in step S43, the replenishment management unit 370 sends a print permission notification to the image forming apparatus 1. In step S44, the image forming apparatus 1 transitions to a print-capable state where a print instruction is received from the user. In step S45, the data management unit 350 updates the status 334 in the apparatus registration table 330 to "replenishment appropriate", updates the remaining amount of toner 335 with the remaining amount of toner received in step S41, and updates the status 344 in the delivery pack table 340 to "used".

In step S46, the replenishment management unit 370 sends, to the image forming apparatus 1, the lock instruction for causing the lock mechanism 52 of the image forming apparatus 1 to lock the opening/closing mechanism 51. In step S47, the lock control unit 96 of the image forming apparatus 1 causes the lock mechanism 52 to lock the opening/closing mechanism 51 again in response to reception of the lock instruction from the management server 301. FIG. 17B illustrates a flow of processing that can be executed during replenishment management in a case where it is determined that re-replenishment is necessary in step S218 and it is determined that the replenishment is inappropriate in step S219. Steps S21 to S42 are similar to those in FIG. 14A, and thus description thereof is omitted.

In step S42, if it is determined that the replenishment is inappropriate, in step S47, the management server 301 sends an inappropriate replenishment notification to the person in charge of replenishment management. In step S48, the data management unit 350 updates the status 334 in the apparatus registration table 330 to "replenishment inappropriate", and updates the status 344 in the delivery pack table 340 to "unknown". In step S49, the replenishment management unit 370 sends, to the image forming apparatus 1, the lock instruction for causing the lock mechanism 52 of the image forming apparatus 1 to lock the opening/closing mechanism 51. In step S50, the lock control unit 96 of the image forming apparatus 1 causes the lock mechanism 52 to lock the opening/closing mechanism 51 again upon reception of the lock instruction from the management server 301.

As described above, in the second embodiment, a magnitude relationship between the toner replenishment amount calculated in step S213 and the toner content of the shipped replenishment pack 200 read out in step S214 is included in the replenishment determination. With this configuration, it can be determined that there is a possibility that not all the toner in the replenishment pack 200 has been replenished although the user has executed replenishment using the shipped replenishment pack 200. In such a case, a re-replenishment instruction may be issued to assist the user in performing replenishment appropriately using the shipped replenishment pack 200.

The technique according to the present disclosure can be widely applied to image forming apparatuses in general, such as a copying machine, a printer, a facsimile receiver, and a multifunction peripheral. Further, while a configuration in which, by using the replenishment pack 200 as an example, a toner container is attached to the image forming apparatus 1 has been described; however, the present disclosure can also be applied to a configuration in which a cartridge type consumable is attached to the image forming apparatus 1.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-049023, filed March 24, 2025, which is hereby incorporated by reference herein in its entirety.

What is claimed is:

1. A replenishment management system comprising:
an image forming apparatus to which a toner container accommodating toner to be used for image formation is detachably attachable; and
a server apparatus configured to manage delivery of the toner container to be used for the image forming apparatus,
wherein the image forming apparatus includes:
a storage portion configured to store toner replenished from the attached toner container;
at least one memory that stores a set of instructions;
at least one processor that executes the instructions causing the image forming apparatus to perform operations comprising:
a detection unit configured to detect a remaining amount of toner in the storage portion; and
a notification unit configured to notify the server apparatus of information about the remaining amount of toner detected by the detection unit, and
wherein the server apparatus includes:
at least one memory that stores a set of instructions;
at least one processor that executes the instructions causing the server apparatus to perform operations comprising:
a determination unit configured to determine whether toner replenishment from the toner container to the image forming apparatus has been appropriately performed based on information about a content of toner accommodated in a new toner container in a case where the new toner container to be used for the image forming apparatus is delivered, and information about the remaining amount of toner notified from the image forming apparatus after the toner container is delivered.

2. The replenishment management system according to claim 1, wherein the server apparatus further includes an instruction unit configured to instruct a person in charge of delivery to deliver a toner container upon reception of information about the remaining amount of toner notified from the image forming apparatus.

3. The replenishment management system according to claim 1, wherein, in a case where a difference between a toner replenishment amount calculated based on a difference between the remaining amount of toner before replenishment and the remaining amount of toner after replenishment that are notified from the image forming apparatus after the toner container is delivered and the content of toner accommodated in the toner container falls within a predetermined range, the determination unit determines that toner replenishment from the toner container to the image forming apparatus has been appropriately performed.

4. The replenishment management system according to claim 1, wherein an amount of toner replenished to the image forming apparatus is calculated based on a difference between the remaining amount of toner before the toner replenishment and the remaining amount of toner after the toner replenishment that are notified from the image forming apparatus after the toner container is delivered, and in a case where the calculated amount of toner is less than the content of toner accommodated in the toner container, the determination unit determines that re-replenishment of toner to the image forming apparatus is to be performed.

5. The replenishment management system according to claim 1, wherein the server apparatus further includes a storage unit configured to store information about shipment of a toner container and information about a content of toner accommodated in the toner container.
